(19) United States
(12) Patent Application Publication
(10) Pub. No.: US 2014/0027522 A1
(43) Pub. Date: Jan. 30, 2014

(54) Thermostat Structure

(71) Applicants: HYUNDAI MOTOR COMPANY, Seoul (KR); KIA MOTORS CORPORATION, Seoul (KR)

(72) Inventor: Philgi LEE, Suwon-si (KR)

(73) Assignees: Kia Motors Corporation, Seoul (KR); Hyundai Motor Company, Seoul (KR)

(21) Appl. No.: 13/710,049

(22) Filed: Dec. 10, 2012

(30) Foreign Application Priority Data
Jul. 27, 2012 (KR) 10-2012-0082733

(51) Int. Cl. F01P 7/16; G05D 23/02

(52) U.S. Cl. CPC F01P 7/16; G05D 23/022
USPC 236/34.5; 236/101 R

(57) ABSTRACT

A thermostat structure may include a valve configured to open or close a flow path through which a coolant flows, and a spring configured to elastically bias the valve to control a flow rate of the coolant flowing to an engine by automatically opening or closing the valve according to a change in a temperature of the coolant, wherein an upper portion of the spring may be coupled to a valve guide configured to support the valve, and may be formed in a shape of a semi-beehive having a uniform radius at a portion coupled to the valve guide and having an increasing radius as being closer to the lower portion thereof.

### CROSS-REFERENCE TO RELATED APPLICATION

The present application claims priority to Korean Patent Application No. 10-2012-0082733 filed on Jul. 27, 2012, the entire contents of which is incorporated herein for all purposes by this reference.

### BACKGROUND OF THE INVENTION

1. Field of the Invention

The present invention relates to a thermostat structure, and more particularly, to a thermostat structure in which a mounting structure of a spring elastically supporting a valve of a thermostat is simplified, thereby reducing a cost.

2. Description of Related Art

In general, a thermostat for a vehicle is installed between an engine and a radiator, and is automatically opened/closed according to a change in a temperature of a coolant to adjust a flow rate flowing toward the engine thus serving to maintain an appropriate temperature of the coolant.

Most of the thermostats for a vehicle in the related art are a mechanical thermostat having a structure in which power by expansion of wax is transferred to a piston to incur an open/close displacement of a valve.

However, the mechanical thermostat employs a method of operating according to an open/close temperature set as a specified temperature, that is, a method of simply opening/closing a valve only at a preset temperature. Accordingly, in consideration of recent trends of gradually implementing high performance and high efficiency of a vehicle, there is a limit in actively handling a change of a driving environment or other conditions of the vehicle.

An electronic thermostat employing a variable control method for maintaining a temperature of a coolant of an engine in an optimum state while complementing a drawback of the mechanical thermostat has been recently suggested.

The electronic thermostat controls the temperature of the coolant of the engine according to a driving environment, such as a load state of the vehicle and the like, so that it is possible to always maintain an optimum engine cooling state and expect effects of improving fuel efficiency and decreasing an exhaust gas compared to the mechanical thermostat.

FIG. 1 illustrates an example of the electronic thermostat. As illustrated in FIG. 1, the electronic thermostat generally has a structure in which wax 2 is accommodated in a pallet 1, a heat generation unit 3, such as a film resistant heater, is embedded at a front end thereof, and the heater generates heat through an external power supply plug to expand the wax and push a piston, so that a valve is operated. A main valve 5 opening/closing a flow path 4 is connected with a valve guide 6 and receives restoration force from a main spring 7 positioned under the main valve 7.

However, in the electronic thermostat in the related art, as illustrated in FIG. 1, it is necessary to separately install a frame 7 in order to fix the main spring 7 for providing restoration force to the main valve 5. Further, although it is not illustrated in the drawing, in a mechanical thermostat in the related art, a separate frame is installed outside in order to fix a main spring for providing restoration valve to a main valve of the mechanical thermostat, similar to the electronic thermostat.

Accordingly, in the mechanical or electronic thermostat in the related art, the separate frame is installed in order to fix the main spring, so that the number of components increases, it is advantageous in terms of cost, and a structure of the thermostat becomes complex.

Further, when the main spring is mounted to the thermostat without a separate fixed structure, such as the frame, the spring leaves a proper position when the thermostat is slantly or horizontally mounted, thereby incurring an operational error.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a thermostat structure having advantages of preventing an operational error of a thermostat, making better use of a space, and reducing a cost by fixing a main spring with a simple configuration.

In an aspect of the present invention, a thermostat structure for controlling a flow rate flowing to an engine while being automatically opened or closed according to transference of force by expansion of wax according to a change in a temperature of a coolant to a piston, may include a housing connected to a flow path through which the coolant of the engine flows, a valve configured to open or close the flow path by a movement of the piston, a valve guide connected to the valve to guide a movement of the valve inside the housing, and a spring configured to elastically bias the valve to the flow path, wherein an accommodating space accommodating the spring is formed at an opposite side of the valve of the housing, an upper portion of the spring is coupled to the valve guide, and a lower portion of the spring is accommodated in the accommodating space around the valve guide.

The upper portion of the spring may include a forcibly inserted portion to be forcibly inserted in and coupled to an upper portion of the valve guide.

Remaining portions except for the forcibly inserted portion in the spring are shaped of a beehive, a radius of which gradually becomes larger as being closer to the lower portion thereof.

An upper side of the valve guide connected with the valve is formed as a circular mounting portion having a predetermined height, so that the forcibly inserted portion of the spring is forcibly inserted on the mounting portion.

The forcibly inserted portion is formed in a predetermined thickness to be forcibly inserted in the valve guide, and a radius of the forcibly inserted portion is uniform.

The forcibly inserted portion is formed in the same thickness as a height of the mounting portion and a radius of the forcibly inserted portion is uniform.

The thermostat is a mechanical or electronic thermostat.

The spring is formed in a shape of a semi-beehive having a uniform diameter at a portion coupled to the upper portion of the valve guide and having an increasing diameter as being closer to the lower portion thereof.

In another aspect of the present invention, a thermostat structure may include a valve configured to open or close a flow path through which a coolant flows, and a spring configured to elastically bias the valve to control a flow rate of the coolant flowing to an engine by automatically opening or closing the valve according to a change in a temperature of the coolant, wherein an upper portion of the spring is coupled to a valve guide configured to support the valve, and is formed in a shape of a semi-beehive having a uniform radius at a portion coupled to the valve guide and having an increasing radius as being closer to the lower portion thereof.

An upper portion of the spring may include a forcibly inserted portion to be forcibly inserted in and coupled to the valve guide.

An upper side of the valve guide is formed as a circular mounting portion having a predetermined height, so that the forcibly inserted portion of the spring is forcibly inserted in the mounting portion.

The forcibly insertion portion is formed in the same thickness as a height of the mounting portion.

According to the thermostat structure of the present invention, it is possible to stably install the spring for elastically supporting the value of the thermostat inside the housing without a separate frame, thereby simplifying the structure of the thermostat and reducing a cost.

Further, according to the thermostat structure of the present invention, the spring is formed in a shape of a semi-beehive, so that the spring may be stably operated without leaving inside the housing of the thermostat even though the thermostat structure is slantly or horizontally installed in the flow path.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of an electronic thermostat in the related art.

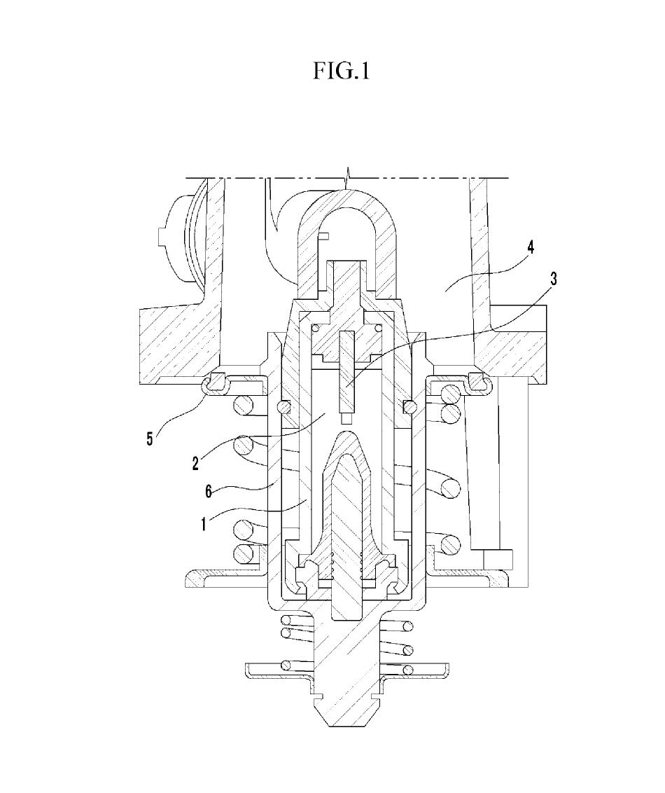

FIG. 2 is a cross-sectional view of a thermostat structure according to an exemplary embodiment of the present invention.

FIG. 3 is a cross-sectional view of a principal part of a thermostat structure according to an exemplary embodiment of the present invention.

FIG. 4 is an exploded sectional view of a principal part of a thermostat structure according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

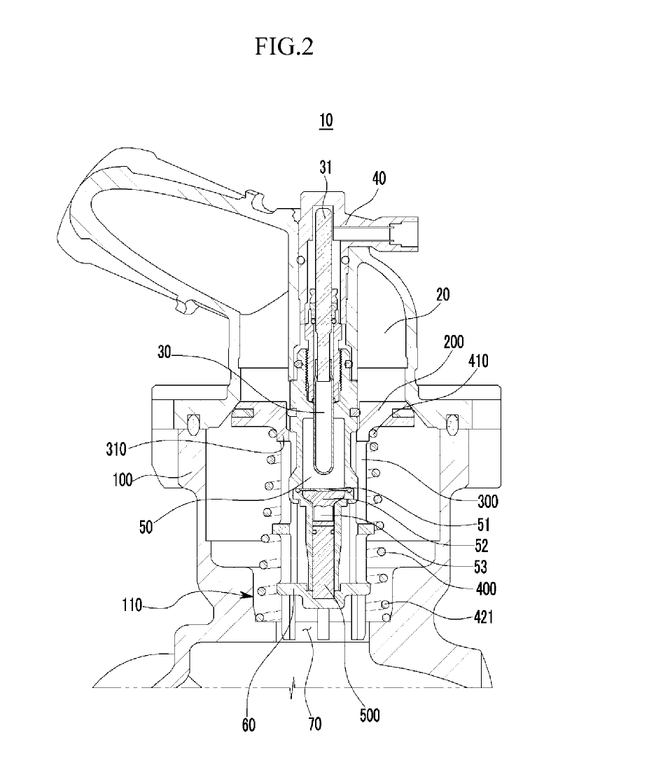

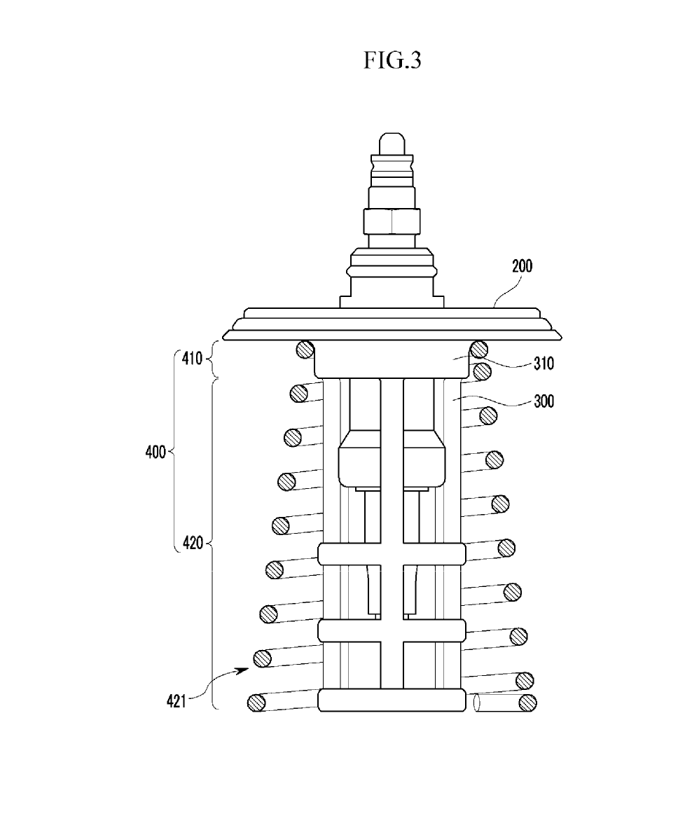

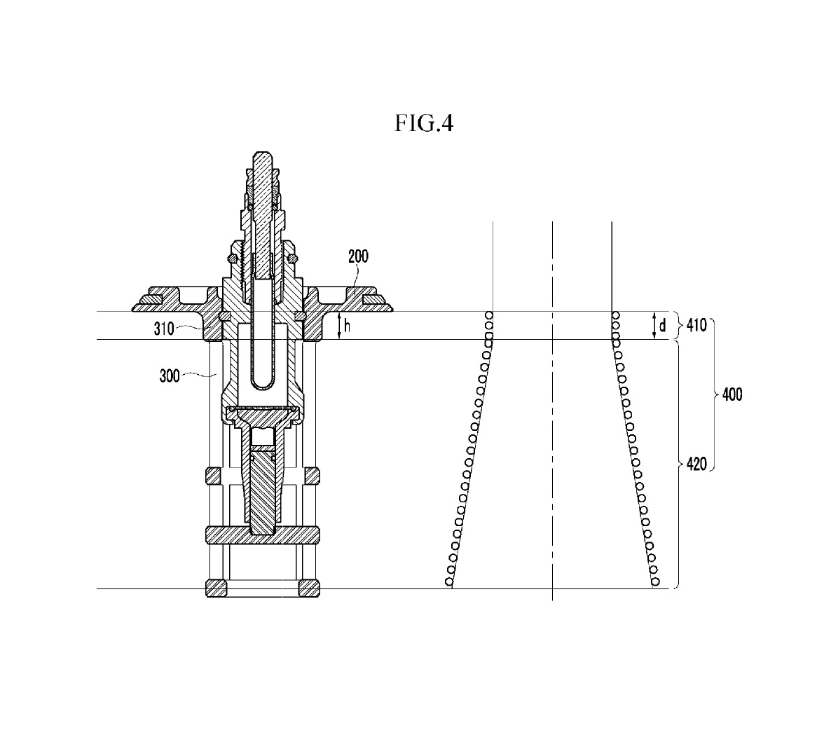

FIG. 2 is a cross-sectional view of a thermostat structure 10 according to an exemplary embodiment of the present invention, FIG. 3 is a cross-sectional view of a principal part of a thermostat structure 10 according to an exemplary embodiment of the present invention, and FIG. 4 is an exploded sectional view of a principal part of a thermostat structure 10 according to an exemplary embodiment of the present invention.

A thermostat adjusts a flow rate flowing to the engine while being automatically opened/closed according to transference of power by expansion of wax 50 to a piston 500 according to a change in a temperature of a coolant, and the thermostat structure 10 according to the exemplary embodiment of the present invention may be applied to both a mechanical thermostat and an electronic thermostat.

However, hereinafter, for the convenience of description, an electronic thermostat will be described as an example.

As illustrated in FIGS. 2 to 4, the thermostat structure 10 according to the exemplary embodiment of the present invention may generally include a housing 100, a valve 200, a valve guide 300, and a spring 400, and may include a heater 30, a connector 40, and the wax 50 when the thermostat structure 10 is applied to the electronic thermostat.

The housing 100 is connected to a plurality of flow paths through which a coolant of an engine of a vehicle flows.

The housing 100 may be connected with a radiator-side flow path 20 through which the coolant flows in after circulating through the radiator 20, a bypass flow path 70 through which the coolant directly circulates toward a water pump of the engine without circulating through the radiator, and a water pump-side flow path at an inlet through which the coolant flows in the engine.

As illustrated in FIG. 2, an internal structure may be formed inside the housing 100 so that the valve 200, the valve guide 300, the connector 40, the spring 400, the heater 30, and the like may be fixed.

In the electronic thermostat structure 10 illustrated in FIG. 2, the connector 40 connected to an external power source is installed in the housing 100 and electricity is conducted to an interior along a core shaft 31 connected with the connector 40, thereby making the heater 30 generate heat. The film resistant heater 30 or the glow plug type heater 30 may be applied inside the heater 30, and the heater 30 is accommodated inside the wax 50. Accordingly, the electronic thermostat structure 10 has a structure in which the heater 30 generates heat to expand the wax 50 and push the piston 500, so that the valve 200 is operated.

The housing 100 may be provided with a predetermined accommodating space 110 having a radius larger than that of the valve guide 300 so as to accommodate a lower portion 421 of the spring 400 at an opposite side of the valve 200, that is, a lower portion in FIG. 2.

The valve 200 is installed inside the housing 100 and opens/closes the flow path 20 by a movement of the piston 500. The flow path 20 may be the radiator-side flow path 20 connected so as to circulate through the radiator, and the valve 200 may be the main valve 200 for opening/closing the flow of the coolant in the radiator side.

The valve guide 300 is connected to the lower portion of the valve 200, and guides a movement of the valve 200 inside the housing 100.

An upper portion of the valve guide 300 may be connected with the main valve 200 for opening/closing the radiator-side flow path 20, and a lower portion thereof may be connected with the bypass valve 60 for opening/closing the bypass flow path 70. The bypass flow path 70 means a flow path making the coolant directly circulate to the water pump of the engine without circulating through the radiator.

In one or multiple exemplary embodiments, as illustrated in FIG. 2, the valve guide 300 may be formed as a cylindrical frame, and especially, an upper portion thereof connected with the valve 200 may be formed as a mounting portion 310 having a predetermined height h so that an upper portion 410 of the spring 400 is forcibly inserted in the mounting portion 310.

In the meantime, a component, such as the piston 500, is disposed inside the valve guide 300. A rubber moving body 53 may be disposed on the piston 500, an upper portion of the rubber moving body 53 may be filled with a transmission fluid 52 formed of a semifluid, and a diaphragm 51 may be included between an upper surface of the transmission liquid 52 and the wax 52.

A space filled with the transmission fluid 52 inside the valve guide 300 may be formed as a slanted surface a diameter of which becomes gradually smaller as becoming closer from an upper portion at which the diaphragm 51 is installed to a lower portion, so that pressure of the transmission fluid 52 according to deformation of the diaphragm 51 may be concentrated to the rubber moving body 53, and the rubber moving body 53 pressurizes the piston 500 under the rubber moving body 53 with force of the concentrated pressure again. Accordingly, through the aforementioned structure, the expansion pressure of the wax 50 may be transferred to the piston 500 without loss, so that it is possible to accurately control flow of the coolant.

The spring 400 is a part elastically supporting the valve 200 to the flow path 20.

An upper portion of the spring 400 is coupled to the valve guide 300, and a lower portion thereof is accommodated inside the accommodating space 110 at the lower portion of the housing 100 to be supported.

An upper side of the spring 400 is formed as a forcibly inserted portion 410 so as to be forcibly inserted and mounted in the valve guide 300. However, the present invention is not limited to the configuration in which the spring 400 is forcibly inserted and mounted in the valve guide 300, and the upper portion of the spring 400 may be coupled to the valve guide 300 by various methods.

Accordingly, according to an exemplary embodiment of the present invention, the upper portion of the spring 400 is forcibly inserted in the valve guide 300 and the lower portion thereof is accommodated in the accommodating space 110 of the housing 100 to be supported, so that it is possible to support the spring 400 with a simple structure without installing the separate frame similar to the related art. Accordingly, it is possible to omit a component, such as the frame, and it is advantageous in terms of both a cost and a space.

In the meantime, in one or multiple exemplary embodiments, the forcibly inserted portion 410 may be forcibly inserted in the mounting portion 310 formed on the valve guide 300. To this end, a thickness d of the forcibly inserted portion 410 may be the same as a height h of the mounting portion 310.

Further, the spring 400 may be shaped like a semi-beehive.

In one or multiple exemplary embodiments, a radius of the forcibly inserted portion 410 mounted in the mounting portion 310 of the valve guide 300 is equally formed to be a uniform radius, and the remaining portions except for the forcibly inserted portion 410 in the spring 400 are formed in the shape of a beehive a radius of which becomes larger as being closer to the accommodating space 110 of the housing 100, so that the spring 400 may be entirely formed in the semi-beehive shape as illustrated in FIG. 4.

Since the forcibly inserted portion 410 has all the same radiuses in the predetermined thickness d to be forcibly inserted in the mounting portion 310 of the valve guide 300 corresponding to the forcibly inserted portion 410, forcible insertion force increases by the thickness d, so that the forcibly inserted portion 410 may be strongly mounted in the mounting portion 310.

In the semi-beehive shaped spring 400, when only the forcibly inserted portion 410 at the upper portion of the spring 400 is forcibly inserted and mounted in the valve guide 300, the spring 400 may be stably supported even though the spring 400 is freely accommodated in the accommodating space 110 without a separate fixing member because the radius of the forcibly inserted portion 410 increases as being closer to the lower portion.

Accordingly, even when the thermostat structure 10 is mounted in a slanted or horizontal state in the flow path 20, when the semi-beehive shaped spring 400 is applied as described above, there is an effect in that the spring 400 does not leave the proper position.

In the meantime, the thermostat structure 10 according to the exemplary embodiment of the present invention may be equally applied to the mechanical thermostat. The mechanical thermostat also basically includes the housing 100 connected to the flow paths through which the coolant of the engine flows, the valve 200 for opening/closing the housing 100, the valve guide 300 for supporting the valve 200, and the spring 400 for elastically supporting the valve. Accordingly, the spring 400 is stably installed without a separate structure by forcibly inserting and mounting the semi-beehive shaped spring 400 in the upper portion of the valve guide 300, forming the spring accommodating space 110 at the lower portion of the housing 100, and accommodating the lower portion 421 of the spring 400 inside the spring accommodating space 110, thereby simplifying a structure and reducing a cost.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A thermostat structure for controlling a flow rate flowing to an engine while being automatically opened or closed according to transference of force by expansion of wax according to a change in a temperature of a coolant to a piston, the thermostat structure comprising:
a housing connected to a flow path through which the coolant of the engine flows;
a valve configured to open or close the flow path by a movement of the piston;
a valve guide connected to the valve to guide a movement of the valve inside the housing; and
a spring configured to elastically bias the valve to the flow path,
wherein an accommodating space accommodating the spring is formed at an opposite side of the valve of the housing, an upper portion of the spring is coupled to the valve guide, and a lower portion of the spring is accommodated in the accommodating space around the valve guide.

2. The thermostat structure of claim 1, wherein:
the upper portion of the spring includes a forcibly inserted portion to be forcibly inserted in and coupled to an upper portion of the valve guide.

3. The thermostat structure of claim 2, wherein:
remaining portions except for the forcibly inserted portion in the spring are shaped of a beehive, a radius of which gradually becomes larger as being closer to the lower portion thereof.

4. The thermostat structure of claim 2, wherein:
an upper side of the valve guide connected with the valve is formed as a circular mounting portion having a predetermined height, so that the forcibly inserted portion of the spring is forcibly inserted on the mounting portion.

5. The thermostat structure of claim 2, wherein:
the forcibly inserted portion is formed in a predetermined thickness to be forcibly inserted in the valve guide, and a radius of the forcibly inserted portion is uniform.

6. The thermostat structure of claim 4, wherein:
the forcibly inserted portion is formed in the same thickness as a height of the mounting portion and a radius of the forcibly inserted portion is uniform.

7. The thermostat structure of claim 1, wherein:
the thermostat is a mechanical or electronic thermostat.

8. The thermostat structure of claim 2, wherein:
the spring is formed in a shape of a semi-beehive having a uniform diameter at a portion coupled to the upper portion of the valve guide and having an increasing diameter as being closer to the lower portion thereof.

9. A thermostat structure comprising:
a valve configured to open or close a flow path through which a coolant flows; and
a spring configured to elastically bias the valve to control a flow rate of the coolant flowing to an engine by automatically opening or closing the valve according to a change in a temperature of the coolant,
wherein an upper portion of the spring is coupled to a valve guide configured to support the valve, and is formed in a shape of a semi-beehive having a uniform radius at a portion coupled to the valve guide and having an increasing radius as being closer to the lower portion thereof.

10. The thermostat structure of claim 9, wherein:
an upper portion of the spring includes a forcibly inserted portion to be forcibly inserted in and coupled to the valve guide.

11. The thermostat structure of claim 10, wherein:
an upper side of the valve guide is formed as a circular mounting portion having a predetermined height, so that the forcibly inserted portion of the spring is forcibly inserted in the mounting portion.

12. The thermostat structure of claim 11, wherein:
the forcibly insertion portion is formed in the same thickness as a height of the mounting portion.
